(19) United States
(12) Patent Application Publication
(10) Pub. No.: US 2007/0046035 A1
(43) Pub. Date: Mar. 1, 2007

(54) Vehicle door latch

(76) Inventor: Robert Frank Tolley, Staffordshire (GB)

Correspondence Address: CARLSON, GASKEY & OLDS, P.C., 400 WEST MAPLE ROAD, SUITE 350, BIRMINGHAM, MI, 48009, US

(21) Appl. No.: 11/492,203

(22) Filed: Jul. 24, 2006

(30) Foreign Application Priority Data
Jul. 30, 2005 (GB) 0515733.4

(51) Int. Cl. E05C 3/06

(52) U.S. Cl. 292/201

(57) ABSTRACT

A vehicle door latch includes a latch bolt for engaging a first striker and a drive lever for driving a second striker. Each of the latch bolt and the drive lever have a closed position corresponding to a closed condition of the latch and an intermediate position corresponding to an intermediate condition of the latch in which the latch is not closed, but the first striker is retained by the latch bolt. The latch further includes a pawl for releasably retaining the latch bolt in each of the closed position and the intermediate position and a power actuator capable of driving the drive lever from the intermediate position to the closed position to close the latch.

### REFERENCE TO RELATED APPLICATION

This application claims priority to United Kingdom Application GB 0515733.4 filed on Jul. 30, 2005.

### BACKGROUND OF INVENTION

This invention relates to vehicle door latches, and in particular, but not exclusively, to vehicle lift gate (tailgate) or boot (trunk) power closure latches for land vehicles such as cars (automobiles).

It is common to provide power closure latches in order to overcome the significant seal loads experienced when closing a modern passenger door of a car. This increased seal load is generated by the requirement to insulate the vehicle cabin from the noise and temperature of the outside environment.

Historically, manually operated latches have been provided with a latch bolt which engages an associated striker. The latch bolt is retained by a pawl which is operated by a manually release element, such as an outside door or liftgate handle, to release the striker and thereby open the door or liftgate.

Typically, known power closure latches for passenger doors simply use a power drive to directly drive the latch bolt from an intermediate position (also known as a safety position in which the door is not closed, but equally cannot be pulled open) which is achieved by conventional closing of the door or liftgate, to the fully closed position. Such a solution has the benefit that it is relatively compact. However, one significant drawback of this design is the complexity of the mechanism required to drive the latch bolt to the fully closed position and subsequently retract in order to allow the liftgate to be opened. Furthermore, the packaging of the latch bolt and the power closure mechanism to drive that latch bolt dictates a particular range (or shape) of space envelopes into which the latch can be fitted. This can prove problematic in terms of arranging the latch in the vehicle door.

Accordingly, it is an object of the present invention to provide a vehicle door latch which overcomes or at least mitigates some of the problems described above.

### BRIEF SUMMARY OF INVENTION

Thus, according to a first aspect of the present invention there is provided a vehicle door latch having a latch bolt for engaging a first striker, and a drive lever for driving a second striker, each of the latch bolt and drive lever having a closed position corresponding to a closed condition in the latch and an intermediate position corresponding to an intermediate condition of the latch in which the latch is not closed, but the first striker is retained by the latch bolt, the latch further including a pawl for releasably retaining the latch bolt in each of its closed and intermediate positions, and a power actuator capable of driving the drive lever from its intermediate position to its closed position so as to close the latch.

According to a second aspect of the present invention there is provided a vehicle door latch system as defined in claim 11.

According to a third aspect of the present invention there is provided a method of controlling one or more vehicle door latches, as defined in claim 12.

### BRIEF DESCRIPTION OF DRAWINGS

The invention will now be described, by way of example only, and with reference to the accompanying drawings, in which:

FIG. 1 is a schematic representation of a latch according to the present invention,

FIGS. 2 to 5 are schematic representations of the latch of FIG. 1 showing the transition of the latch from an open condition shown in FIG. 2 to a closed condition shown in FIG. 5,

FIG. 6 is a perspective view of a striker assembly of the latch of FIGS. 1 to 5,

FIGS. 7 and 8 are perspective views of alternative embodiments of striker assembly according to the present invention,

FIGS. 9 to 12 are schematic diagrams of a control system according to the present invention showing the transition of the system from an open state shown in FIG. 9 to a closed state shown in FIG. 12, and

FIGS. 13 to 16 are schematic diagrams of a further control system according to the present invention showing the transition of the system from an open state shown in FIG. 13 to a closed state shown in FIG. 16.

### DETAILED DESCRIPTION OF INVENTION

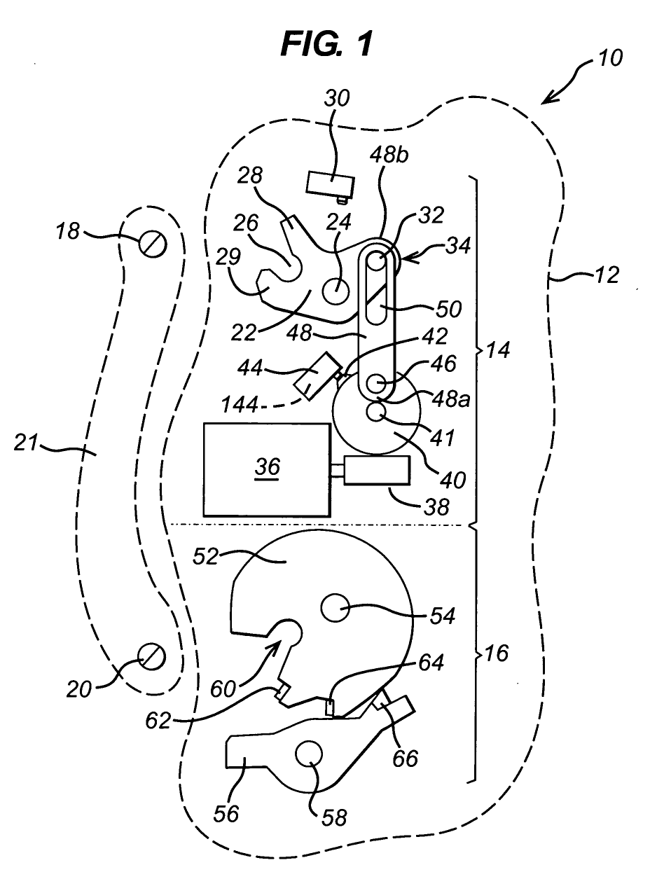

Referring to FIG. 1, a vehicle door latch 10 has a latch chassis, showing schematically at 12 and shown in FIG. 1 only, on which is mounted a power closure assembly 14 and a latching assembly 16. A first striker 18 is provided for engagement with the power closure assembly 14 and a second striker 20 is provided for engagement with the latching assembly 16 as will be described in further detail shortly.

The vehicle door latch 10 is mounted by way of the latch chassis 12 on a vehicle body (not shown for clarity). The first and second strikers 18, 20 are fixed to a vehicle lift gate 21 (shown schematically in FIG. 1 only) in order that they engage the power closure assembly 14 and latching assembly 16, respectively, when the lift gate is closed by an operator.

In a preferred embodiment, the vehicle door latch is mounted by way of the latch chassis on a vehicle lift gate instead of the vehicle body, and the first and second strikers are cooperatively mounted on the vehicle body. The non-preferred embodiment is herein described in order to ease description of the mode of operation of the latch.

The power closure assembly 14 includes a drive lever 22 mounted for rotation about a pivot 24. The drive lever 22 has a mouth 26 for receiving the first striker 18, a switch arm 28 for intermittently engaging a drive lever switch 30 as will be discussed in further detail shortly. The drive lever 22 has an abutment 32 (in the form of a projecting pin) arranged on a drive arm 34 and a striker tooth 29 arranged on the opposite side of the mouth 26 to the switch arm 28.

The power closure assembly 14 further comprises a power actuator in the form of an electric motor 36 which is fixed to the latch chassis 12 and drives a pinion gear 38. The pinion gear 38 in turn drives a closure lever in the form of a gear wheel 40 mounted for rotation on pivot 41 and which defines a lip 42 for intermittently engaging a gear wheel switch 44 as will be described in further detail shortly. The gear wheel 40 further includes a pin 46 for carrying a connection rod 48 which forms a drive connection between the gear wheel 40 and the drive lever 22.

The connection rod 48 has a first end 48a which is rotatably mounted on the gear wheel pin 46 and a second end 48b which defines a lost motion slot 50 for receiving the drive lever abutment 32.

It will be appreciated that the drive lever 22 does not have an associated claw for retaining the drive lever in either of its closed or intermediate positions.

The latching assembly 16 has a latch bolt 52 (in the form of a rotating claw) rotatably fixed to the latch chassis 12 by a latch bolt pivot 54, and a pawl 56 mounted for rotation relative to the latch chassis 12 on pawl pivot 58. The latch bolt 52 is biased for rotation in a clockwise direction when viewing FIG. 1 by a latch bolt spring (not shown for clarity) and the pawl is biased for rotation in an anticlockwise direction when viewing FIG. 1 by a pawl spring (also not shown for clarity). The latch bolt has a mouth 60 for receiving the latch bolt striker 20, and a closed abutment 62 and intermediate abutment 64 for intermittently engaging the pawl 56 as will be described further shortly. The pawl is provided with a pawl tooth 66 for retaining the latch bolt 52 via the intermediate abutment 64 or the closed abutment 62.

It will be appreciated that the drive lever switch 30 may alternatively be arranged for engagement with the latch bolt 52 since the angular rotation of the latch bolt 52 will always match the angle of rotation of the drive lever 22 during operation of the latch as will be described in further detail shortly.

In summary FIGS. 1 to 5 show the sequence of events that occurs when the liftgate is closed.

In FIG. 1, the first and second strikers 18, 20 are not engaged with the drive lever 22 and latch bolt 52, respectively, and the latch is therefore in the open condition. Accordingly, the latch bolt 52 is shown in its open position, the drive lever 22 is shown in its open position, and the gear wheel 40 is shown in its rest position.

As shown in FIG. 1, the drive lever switch 30 is not activated since the switch arm 28 of the drive lever 22 has not made contact with the drive switch 30 in order to activate the switch. When the drive lever switch 30 is in its non activated state, the switch is electrically open, i.e. it does not form a path across which an electrical current can flow.

Throughout the description, the terms activated and non activated refer to the mechanical state of the gear wheel and drive lever switches 44, 30, i.e., in the case of the drive lever switch 30, the engagement or otherwise of the switch arm 28 with the drive lever switch 30.

In contrast to the drive lever switch 30, the gear wheel switch 44 as shown in FIG. 1 is mechanically activated by the lip 42, but is electrically in an open state. In this open electrical state, an electrical signal is not able to pass across the switch as will be described in further detail shortly.

For the avoidance of doubt, it will be appreciated that the drive lever switch 30 and the gear wheel switch 44 operate in a different manner, in that when the drive lever switch 30 is mechanically activated, the switch is in an electrically closed state, and when the gear wheel switch 42 is mechanically activated, it is in an electrically open state. Conversely, when the drive lever switch 30 is in a mechanically non activated state, the switch is electrically open and when the drive lever switch 44 is in a mechanically non activated state, the switch is in an electrically closed state.

In summary, as shown in FIG. 1, the drive lever switch is not activated and is consequently in an electrically open state and the gear wheel switch 44 is activated and as a result is in an electrically open state.

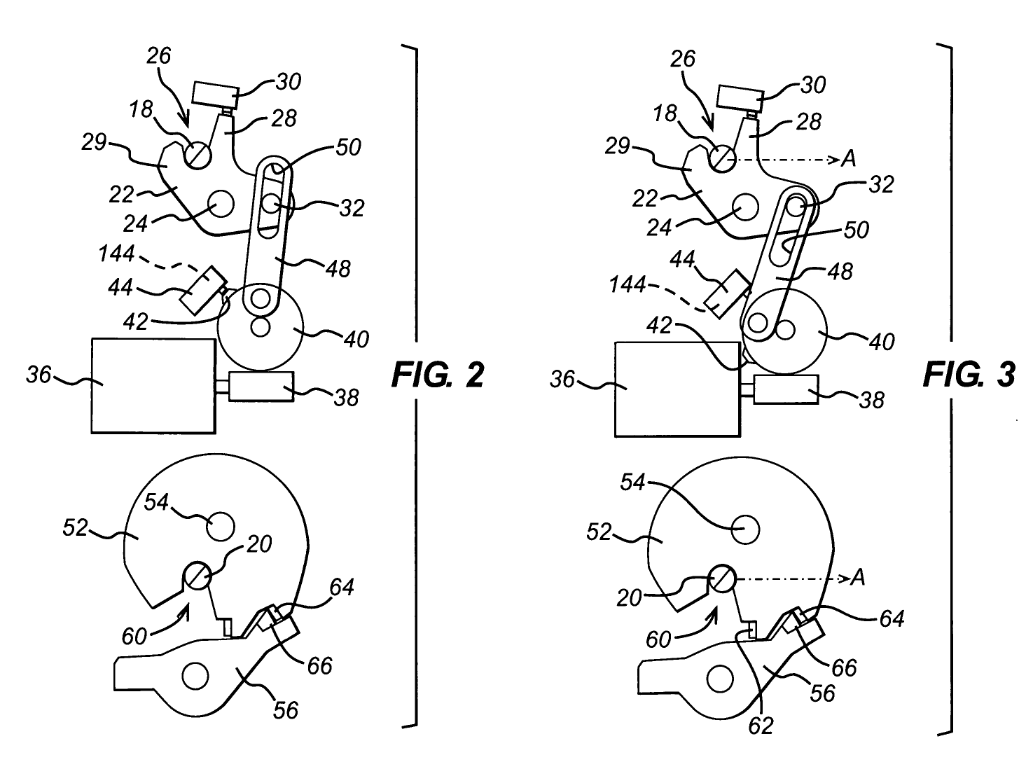

To close the lift gate the operator pushes the lift gate towards the vehicle body, and in doing so moves the first and second strikers 18, 20 towards the latch 10 and into engagement with the drive lever 22 and latch bolt 52, respectively. This moves the latch 10 to its intermediate condition as shown in FIG. 2.

It will be appreciated that the latch bolt 52 and pawl 56 operate in a manner similar to known latches in that the latch bolt is moved to a closed position by engagement with a striker, and the pawl retains the latch bolt 52 in order to keep the latch close. However, there are significant differences in the way in which the second striker is powered to close the latch as will be described further shortly.

It will be appreciated that there is no direct mechanical drive between the power closure assembly 14 and the latching assembly 16. That said however, it is clear that the angle of rotation of the latch bolt 52 will match the angle of rotation of the drive lever 22 during operation of the latch for the following reasons. The first striker 18 and second striker 20 are both mounted on the lift gate. As a result, when the drive lever 22 drives the first striker, the second striker will also be moved by virtue of the mounting of the first and second strikers 18, 20 on the lift gate.

Reference to FIG. 2 shows a transient position of the latch component in which the force of closing the lift gate has caused the second striker 20 to enter the latch bolt mouth 60 to rotate the latch bolt about its pivot 54 from its open position shown in FIG. 1 to its intermediate position shown in FIG. 2. Rotation of the latch bolt 52 has allowed the pawl 56 to rotate under the action of the pawl spring in the anticlockwise direction to move the pawl tooth 66 into engagement with the intermediate abutment 64 of the latch bolt 52. It will be appreciated that with the latch in the intermediate condition as shown in FIG. 2, the latch is not yet in the closed condition, but nonetheless the second striker 20 is retained within the latch bolt mouth 60 by way of engagement of the pawl tooth 66 with the intermediate abutment 64, so as to prevent opening of the latch.

Since both the first striker 18 and second striker 20 are fixably attached to the vehicle liftgate (which in this case is pivoted at an upper edge), it follows that the second striker 20 has followed a parallel path to that of the first striker 18. Consequently, the first striker 18 has entered the mouth 26 of the drive lever 22 which causes the drive lever 22 to rotate about its pivot 24 to its intermediate position. It will be noted that the gear wheel 40, and consequently the connection rod 38 have not moved from their rest position as shown in FIG. 1. Rotation of the gear lever 22 from its open position shown in FIG. 1 to its intermediate position shown in FIG. 2 is permitted by movement of the drive lever abutment 32 within the lost motion slot 50 of the connection rod 48.

In FIG. 2, the drive lever switch 30 is closed in its activated state and the gear wheel switch 44 is open in its activated state.

As mentioned briefly above, as shown in FIG. 2, the gear wheel 40 of the power closure assembly has not yet moved from the rest position. However, in moving from its rest position (FIG. 1) to its intermediate position (FIG. 2) the drive lever 22 has rotated in the clockwise direction to bring the switch arm 28 into engagement with the drive lever switch 30. Activation of the switch 44 electrically closes the switch and allows an electrical signal to pass across it. This signal is detected by central electronic control unit (not shown for clarity) which closes the latch in the following way.

With the drive lever 22 is in its intermediate position, the control unit operates the electric motor 36 to drive the gear wheel 40 in an anticlockwise direction via the pinion gear 38. In this way the power closure assembly is moved from the position shown in FIG. 2 to the position shown in FIG. 3.

In FIG. 3, the drive lever switch 30 is closed in its activated state and the gear wheel switch 44 is closed in its non-activated state.

In FIG. 3, the latch is in a transient position in which the electric motor 36 has driven the connection rod 48 via the pinion gear 38 and gear wheel 40 from the FIG. 2 position so that the drive lever abutment 32 is arranged momentarily at the uppermost end of the lost motion slot 50. With the latch as shown in FIG. 3, the drive lever 22 has not yet moved from its intermediate position, and accordingly has not yet begun to apply a closure load to the first striker 18. It will be appreciated that with the latch in this transient position the interaction of the pawl 56 with the latch bolt 52 retains the second striker 20 and the latch therefore remains in the intermediate condition.

However, further anticlockwise rotation of the gear wheel 40 by the electric motor 36 will begin to move the latch from its transient FIG. 3 position to the positions shown in FIG. 4. As a result the upper end of lost motion slot 50 applies a downward load to the drive lever abutment 32 which causes the drive lever 22 to rotate in a clockwise direction about its pivot 24. This rotation causes the striker tooth 29 of the drive lever 22 to drive the first striker 18 in a direction A. Since the first and second striker 18, 20 are both mounted on the liftgate, any movement in the first striker 18 is accompanied by movement of the second striker 20. It will be appreciated that as the second striker 20 is moved in the direction A, the latch bolt 52 will be caused to rotate in an anticlockwise direction which causes the closed abutment 62 to rotate towards the pawl tooth 66.

Referring now to FIG. 4, in which the drive lever switch 30 is open in non-activated state and the gear wheel switch 44 is closed in its non-activated state, the drive lever 22 has driven the first and second strikers sufficiently far that the second striker 20 has caused the latch bolt 52 to rotate to a position where the closed abutment 62 is engaged by the pawl tooth 66. The latch is now in a closed condition, since the latch bolt 52 cannot escape the pawl tooth 66 unless the pawl tooth 66 is retracted by an operator opening the latch. As shown in FIG. 4, the gear wheel 40 is transiently in its closed position, in distinction from the rest position as shown in FIG. 1.

With the latch transiently in the closed position the electric motor 36 continues to rotate the gear wheel 40 in the clockwise direction (the gear wheel switch 44 is still electrically closed) to the rest position shown in FIG. 5. This movement back to the rest position is to allow subsequent release of the first striker 18, and thereby the opening of the latch.

Referring to FIG. 5, the latch bolt 52 is retained in its closed position by the pawl tooth 66 which keeps the lift gate closed by way of retention of the second striker 20 in the latch bolt mouth 26. The lift gate is safely closed since the controller has controlled the electric motor 36 to move the gear wheel 40 to return to its rest position. When the gear wheel 40 reaches its closed position, the lip 42 activates the gear wheel switch 44 to open the switch 44 and the control unit cuts power to the electric motor 36 accordingly. The drive lever abutment 32 is at rest at the lower end of the lost motion slot 50.

From the closed condition of FIG. 5, the latch may be opened as follows. Operation of a manually actuable element, such an outside release handle 53 (shown schematically in FIG. 5 only) disengages the pawl 56 from the latch bolt 52 via a bowden cable 55 (also shown schematically in FIG. 5 only). The latch bolt 52 is therefore permitted to rotate in the clockwise direction allowing release of the second striker 20 from the latch bolt mouth 26 in direction B as shown in FIG. 5. As the second striker 20 moves in direction B, so does first striker 18 which causes anticlockwise rotation of the drive lever 22. Such rotation of the drive lever 22 is permitted since the drive lever abutment 32 can move from the lower end of the lost motion slot 50 towards the upper end of the lost motion slot 50 as the drive lever 22 rotates to release the first striker 18.

Above is described the power closure of the latch following manual closure to bring the latch into the intermediate condition as shown in FIG. 2. From the position shown in FIG. 2, the power closure assembly is driven to move the latch to a closed condition as shown in FIG. 4, from which position the gear wheel 40 is returned to its rest position as shown in FIG. 5.

However, if the lift gate is closed with sufficient force, the latch will move beyond the intermediate condition shown in FIG. 2 to the closed condition since the second striker 20 is able to apply sufficient force to the latch bolt 52 to rotate the latch bolt to its closed position where it will be retained by the pawl 56. Closure in this manner is permitted since the drive lever 22 can rotate in the clockwise direction beyond its intermediate position shown in FIG. 2 directly to the closed position as shown in FIG. 5. As described above in the position of FIG. 5 both the drive lever switch 30 and the gear-wheel switch 44 are open and consequently no power is transferred to the electrical motor 36 to drive the drive lever 40.

It will be appreciated that in the embodiment described above, the power closure assembly 14 and latching assembly 16 are arranged in close proximity on the latch chassis 12. In alternative embodiments, the power closure assembly and latching assembly may be separated by some distance with each assembly having a separate chassis. The power closure assembly and latching assembly of the embodiment described in detail above are provided in close proximity for ease of manufacture, however, there is no reason why the two assemblies need to be provided in close proximity to one another in the liftgate.

Similarly, the first striker and second striker may either distinct components, or may be formed from a single body. As with their associated power closure assembly and latching assembly, the first and second strikers may either be arranged in close proximity, or be separated by some distance.

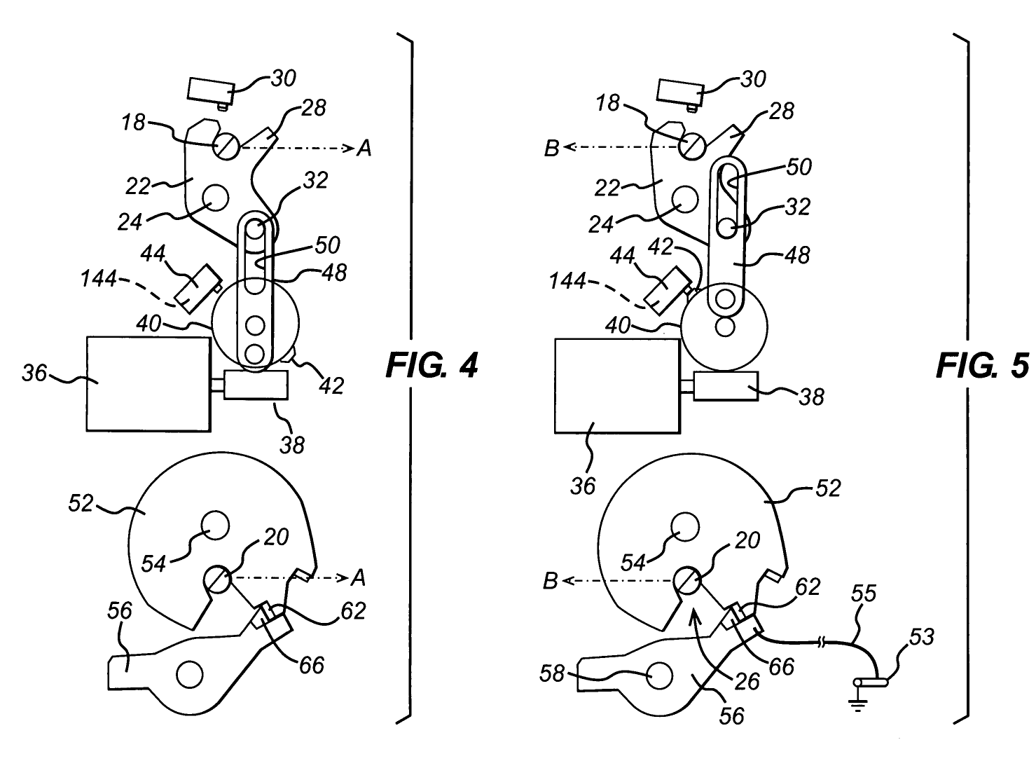

FIG. 6 shows a striker assembly 80 comprising a first loop 81 and a second loop 82. The first and second loops 81, 82 are joined by a bar 83. The loop 81, 82 and bar 83 are formed from a single length of wire, but may be formed separately and joined by, for example, welding. The striker assembly 80 is fixed to a lift gate (not shown for clarity) by a pair of clasps 84. The first loop 81 defines the first striker 18 (shown in FIGS. 1 to 5 in section along line I-I of FIG. 6). Similarly, the second loop 82 defines the second striker 20.

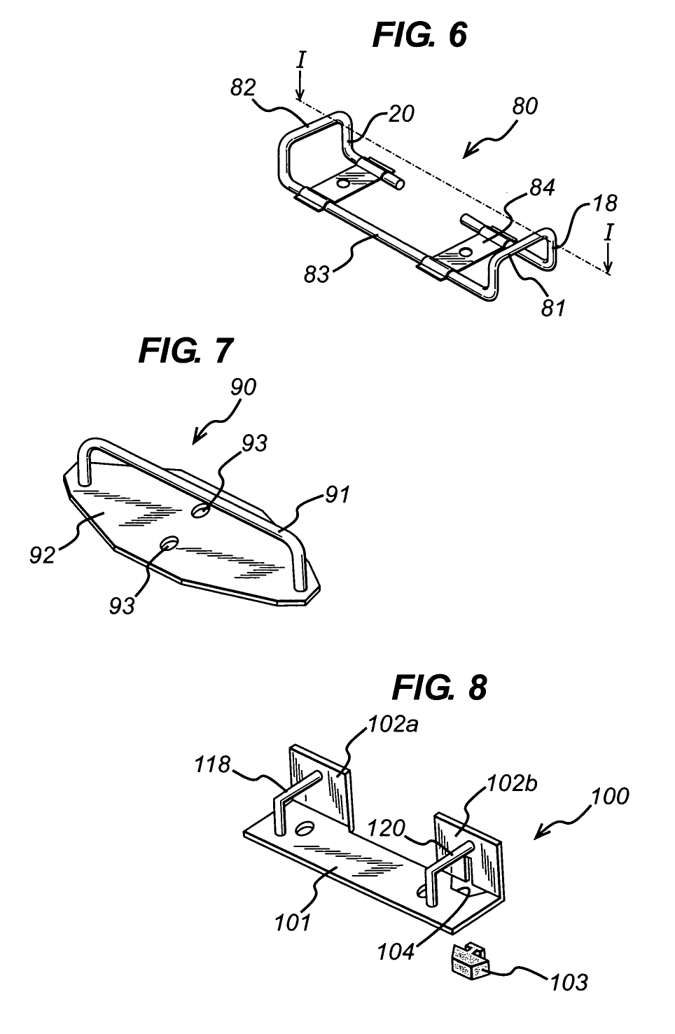

FIG. 7 shows an alternative embodiment of striker assembly 90 formed by a striker bar 91 mounted on a base 92. The base 92 is provided with a pair of mount holes 93 for mounting the striker assembly 90 to a lift gate or vehicle body (not shown for clarity).

FIG. 8 shows a further alternative embodiment of striker assembly 100 comprising a base plate 101 and two side walls 102a, 102b arranged at either end of the base plate 101. A first striker 118 is mounted to the base plate 101 and side walls 102a, and a second striker 120 is mounted to the base plate 101 and side wall 102b. The striker assembly 100 includes an elastomeric wedge 103 for fitting into a slot 104 formed by the base 101 and side wall 102b.

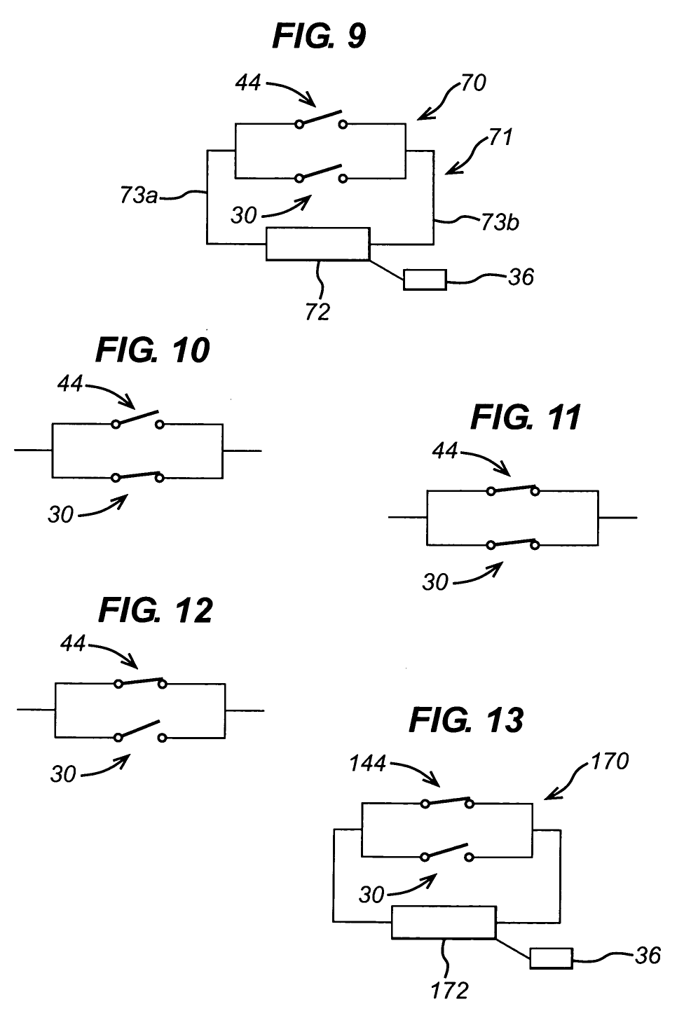

Referring now to FIG. 9, a control system 70 is shown having an electronic control unit 72 which operates the electric motor 36 via the gear wheel switch 44 and drive lever switch 30 as will be described in further detail shortly.

The gear wheel switch 44 and drive lever switch 30 are arranged on parallel paths which are joined to the ECU 72 at one end by a first branch 73a and at the other end by a second branch 73b. The gear wheel switch 44, drive lever switch 30, ECU 72 and first and second branches 73a, 73b, collectively form an electrical loop 71.

With the system as shown in FIG. 9, the drive lever switch 30 and gear wheel switch 44 are open, indicating that the drive lever 22 is either in the open position or the closed position (i.e. not the intermediate position). Since both switches are open no signal is able to pass through the loop 71 and consequently no power is transferred to the electric motor 36 to drive to drive lever.

Turning now to FIG. 10, both the drive lever switch 30 and the gear wheel switch 44 are activated. The control system 70 as depicted in FIG. 10 corresponds to the latch as depicted in FIG. 2. The lift gate has been shut by the operator and consequently, the gear wheel switch 44 is open and the drive lever switch 30 is closed. A signal can now pass around loop 71 via the drive lever switch 30 which powers the actuator 36 to operate the drive lever 22. In doing so, the system is moved to the condition shown in FIG. 11.

The system of FIG. 11 corresponds to the latch of FIG. 3, since the gear wheel switch 44 is no longer activated (and is therefore closed) following the driving of the electric motor 36 to drive the gear wheel 40 towards its closed position. Since the gear wheel switch 44 (and therefore loop 71) is closed a signal is able to pass around the loop 71 and the electrical motor 36 continues to operate the drive lever 22.

In FIG. 12 the gear wheel switch 44 is activated (and is therefore closed) whilst the drive lever switch 30 remains unactivated (and therefore open). The corresponding latch position is shown in FIG. 4. Since the loop 71 remains closed, the actuator continues to drive the lever from the FIG. 4 position to the FIG. 5 position in which both the gear wheel switch 44 and drive lever switch 30 are open. Since no signal is able to pass around the loop 71, no power passes from the ECU to the electric motor 36 and the motor stops driving the drive lever. This brings the gear wheel 40 and connection rod 48 to return to the rest position as shown in FIG. 5.

Whilst the embodiment described above uses a standard electric motor in conjunction with switches to detect position of the gear wheel 40, it will be conceivable within the scope of the invention to provide a stepper motor which will automatically registered the position of the gear wheel, and thereby remove the need for a gear wheel switch 44.

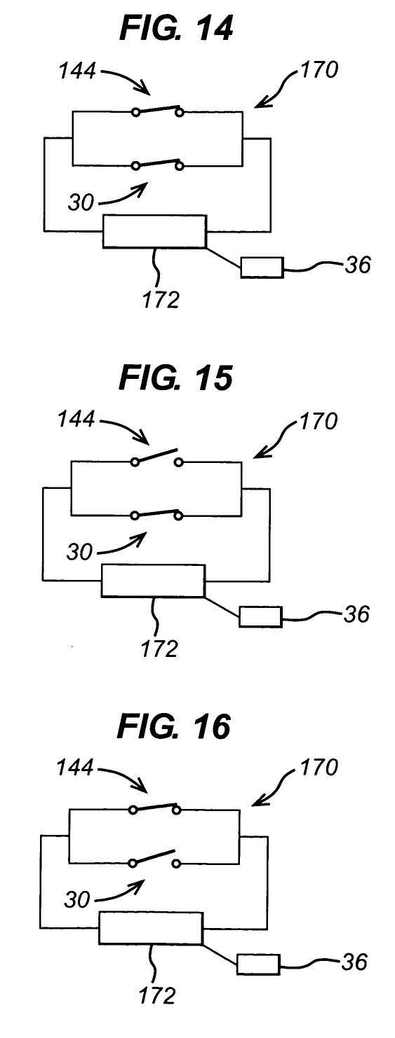

In an alternative embodiment, a control system 170 is provided as shown in FIGS. 13 to 16. The principal difference between the system 170 and the system 70 is that when the gear wheel switch 144 is activated, the switch is closed, and when the switch is not activated, the switch remains open. This is in contrast to gear wheel switch 44 of the first embodiment of control system 70.

In this embodiment, the ECU 172 monitors the position of the switches (30, 144) in order to control operation of the electric motor 36. This is in contrast to the first embodiment in which the open and closed status of the switches was used to dictate whether power is directed to the electric motor. In this embodiment the ECU 172 uses logic to decide the position of the gear wheel and drive lever and consequently whether to power the electric motor. The configuration of the control system 170 shown in FIGS. 13 to 16 corresponds to the position of the latch shown in FIGS. 1 to 4, respectively.

It will be appreciated that the control system is in the state shown in FIG. 13 when the latch is in the open condition as shown in FIG. 1 and the closed condition as shown in FIG. 5. However, the control system is able to differentiate between the two conditions, since the drive lever switch 30 is transiently activated when the latch is opened by an operator to move the latch from the closed position shown in FIG. 5 to the open position shown in FIG. 1.

In this second embodiment, the control unit can be configured such that transient operation of the drive lever switch 30 following the lift gate being slammed straight through to the closed condition does not trigger the driving of the gear wheel 40 and connection rod 48 from the rest position to the closed position and back again as would occur under normal power operation. Alternatively, the controller may be configured to drive the gear wheel 40 upon transient operation of the gear lever switch 30, the provision of the lost motion slot simply allowing the connection rod to move about the drive lever 32 without adversely affecting the mode of the operation of the latch.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

1. A vehicle door latch comprising:
a latch bolt for engaging a first striker;
a drive lever for driving a second striker, wherein each of the latch bolt and the drive lever have a closed position corresponding to a closed condition of the vehicle door latch and an intermediate position corresponding to an intermediate condition of the vehicle door latch in which the vehicle door latch is not closed, but the first striker is retained by the latch bolt;
a pawl for releasably retaining the latch bolt in each of the closed position and the intermediate position; and
a power actuator capable of driving the drive lever from the intermediate position to the closed position to close the vehicle door latch.

2. The vehicle door latch according to claim 1 further including a striker member that defines the first striker and the second striker.

3. The vehicle door latch according to claim 1 wherein a lost motion is generated between the power actuator and the drive lever.

4. The vehicle door latch according to claim 3 further including a drive mechanism for transferring drive from the power actuator to the drive lever.

5. The vehicle door latch according to claim 4 wherein the drive mechanism includes a connection rod having a first end for engaging the drive lever and a second end for engaging a gear wheel driven by the power actuator.

6. The vehicle door latch according to claim 5 wherein a lost motion slot is arranged at the first end of the connection rod, and the drive lever defines an abutment which acts in the lost motion slot.

7. The vehicle door latch according to claim 1 further including a first switch for detecting a position of the drive lever.

8. The vehicle door latch according to claim 7 further including a second switch for detecting a position of the power actuator.

9. The vehicle door latch according to claim 7 wherein the drive lever includes an arm for engaging the first switch.

10. The vehicle door latch according to claim 8 further including a gear wheel driven by the power actuator, wherein the second switch is arranged for engagement with the gear wheel.

11. A vehicle door latch system comprising:
at least one vehicle door latch including:
a latch bolt for engaging a first striker,
a drive lever for driving a second striker, wherein each of the latch bolt and the drive lever have a closed position corresponding to a closed condition of the at least one vehicle door latch and an intermediate position corresponding to an intermediate condition of the at least one vehicle door latch in which the at least one vehicle door latch is not closed, but the first striker is retained by the latch bolt,
a pawl for releasably retaining the latch bolt in each of the closed position and the intermediate position,
a power actuator capable of driving the drive lever from the intermediate position to the closed position to close the at least one vehicle door latch,
a first switch for detecting a position of the drive lever, and
a second switch for detecting a position of the power actuator; and an electronic control unit capable of receiving a signal from each of the first switch and the second switch and controlling the power actuator of each vehicle door latch in response to the signals.

12. A method of controlling at least one vehicle door latch, the at least one vehicle door latch including:
a latch bolt for engaging a first striker,
a drive lever for driving a second striker, wherein each of the latch bolt and the drive lever have a closed position corresponding to a closed condition of the at least one vehicle door latch and an intermediate position corresponding to an intermediate condition of the at least one vehicle door latch in which the at least one vehicle door latch is not closed, but the first striker is retained by the latch bolt,
a pawl for releasably retaining the latch bolt in each of the closed position and the intermediate position,
a power actuator capable of driving the drive lever from the intermediate position to the closed position to close the at least one vehicle door latch,
a first switch for detecting a position of the drive lever, and
a second switch for detecting a position of the power actuator, the method comprising the steps of:
providing an electronic control unit capable of receiving a signal from each of the first switch and the second switch of the at least one vehicle door latch and capable of controlling the power actuator of each vehicle door latch in response to the signals,
detecting activation of the first switch with the electronic control unit;
controlling the power actuator to drive the drive lever to the closed position; and
then controlling the power actuator to drive the drive lever to an open position.
